(19) United States
(12) Patent Application Publication
(10) Pub. No.: US 2008/0222900 A1
(43) Pub. Date: Sep. 18, 2008

(54) Apparatus for Emergency Seatbelt Release

(76) Inventor: Anthony Lee, Davie, FL (US)

Correspondence Address: STEVEN PINKERT , ESQ, PINKERT LAW FIRM ,P.A ONE DATRAN CENTER - STE 1702, 9100 S. DADELAND BLVD, MIAMI, FL, 33156, US

(21) Appl. No.: 12/049,352

(22) Filed: Mar. 16, 2008

Related U.S. Application Data
(60) Provisional application No. 60/918,409, filed on Mar. 16, 2007.

(51) Int. Cl. B60R 22/32

(52) U.S. Cl. 30/298.4

(57) ABSTRACT

The present invention provides an apparatus to facilitate the easy removal or release of a seatbelt or similar safety harness device during an emergency. The apparatus of the invention provides a practical and easy means of releasing a seatbelt or similar safety harness that is jammed or difficult to remove during an auto accident or other emergency. The apparatus is comprised of an Emergency Seatbelt Release (ESR) box which is attached to the seatbelt, preferably at or near the tongue connector of the seatbelt such that the seatbelt passes through the ESR box. The ESR box contains a sharp edged cutting instrument attached to a trigger handle contained in a compartment within the ESR box. The compartment containing the trigger handle has a protective quick access cover so that it will not be inadvertently pulled or snagged in non-emergency situations. When the protective cover is removed, the trigger handle becomes accessible with the aid of compression springs which extend and eject the trigger handle. In an emergency, the trigger handle is pulled and the sharp edge cutting instrument is drawn along the seatbelt, cutting it completely in one forward motion.

### CROSS-REFERENCE TO RELATED APPLICATIONS

This application claims the benefit of U.S. Provisional Application No. 60/918,409 filed on Mar. 16, 2007. The entire disclosure of this prior application is hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

The present invention relates generally to the field of safety as it relates to the quick and easy release of a seatbelt or safety harness during an emergency.

### BACKGROUND OF THE INVENTION

The present invention relates to an apparatus to facilitate the easy removal or release of a seatbelt or similar safety harness device during an emergency. The present invention is attached to the seatbelt or safety harness device. The invention provides a practical and easy means of releasing a seatbelt or similar safety harness that is jammed or difficult to remove during an auto accident or other emergency.

The seatbelt or safety belt is essentially a harness designed to hold in place the occupant of a car or other vehicle against harmful movement that may result from a collision or a sudden stop. As part of an overall occupant restraint system, seatbelts are intended to reduce injuries by stopping the wearer from hitting hard interior elements of the vehicle or other passengers and by preventing the wearer from being thrown from the vehicle.

Although intended as a safety feature in cars, other vehicles and aircraft, the seatbelt can, in certain circumstances, become a safety hazard during and after an emergency if it prevents a passenger from escaping. This invention is designed for use in the event that a seatbelt fails to unlatch or an occupant is unable to unlatch it in an emergency situation. For example, if an overturned vehicle is plunged into a body of water, the occupant becomes trapped in the vehicle by a seatbelt. The occupant may be unable to activate the standard seatbelt release because of the occupant's position, the occupant's limited mobility, the belt's or buckle's position, or a failure of the buckle release mechanism. This device can be used to release the seatbelt. As a further example, if the occupant of a vehicle is rendered unconscious from impact during an accident or similar event, this invention permits fire rescue or a helpful onlooker/passerby to easily release the seatbelt.

### SUMMARY OF THE INVENTION

It is an object of the present invention to provide an added safety feature to an existing seatbelt or similar harness safety device for use in cars, other vehicles, aircraft or other modes of transport. The apparatus of the invention is attached to the seatbelt or similar safety harness.

The invention has multiple components housed in an Emergency Seatbelt Release (ESR) box. The ESR box is attached to the seatbelt apparatus, preferably at or near the tongue connector on either the lap seatbelt portion or the shoulder seatbelt portion, such that the seatbelt passes through the ESR box. The ESR box contains a sharp edged cutting instrument attached to a trigger handle on the outside or accessible from the outside of the ESR. The trigger handle has a protective quick access cover so that it will not be inadvertently pulled or snagged. When the cover is removed, the trigger handle becomes accessible. When the trigger handle is pulled, the blade is drawn along the seatbelt, cutting it completely with one stroke. The movement of the cutting instrument and handle may be assisted by springs.

The components of the invention and specifically the configuration of the contents of the ESR box may be varied to enhance the overall utility and effectiveness of the invention. As well, the ESR box and its contents may be made of varying materials for enhanced construction, ease of operation, and the overall effectiveness of the invention.

### BRIEF DESCRIPTION OF THE DRAWINGS

In describing the invention, reference will at times be made to the accompanying drawings in which:

FIG. 1 is a diagram of the apparatus of the invention attached to the tongue connector portion of a seatbelt in its rest position; and

FIG. 2 is a diagram of the apparatus of the invention attached to the tongue connector portion of the seatbelt showing the components of the Emergency Seatbelt Release box in plain view.

### DESCRIPTION OF INVENTION

Before the subject invention is described further, it is to be understood that the invention is not limited to the particular embodiments of the invention described below, as variations of the particular embodiments may be made and still fall within the scope of the invention. It is also to be understood that the terminology employed is for the purpose of describing particular embodiments, and is not intended to be limiting.

In this specification, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

The details of one or more embodiments of the invention are set forth in the accompanying drawings and the description below. Other features, objects, and advantages of the invention will be apparent from the description and drawings, and from the claims.

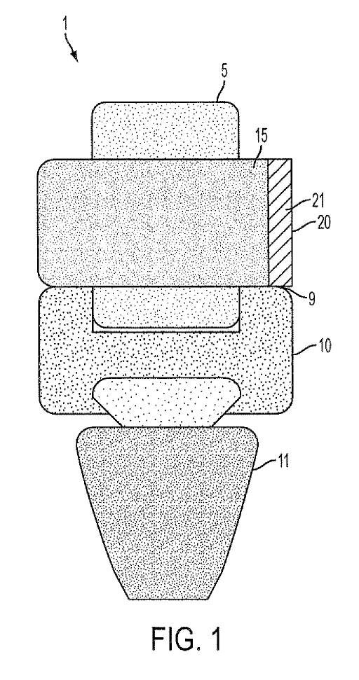

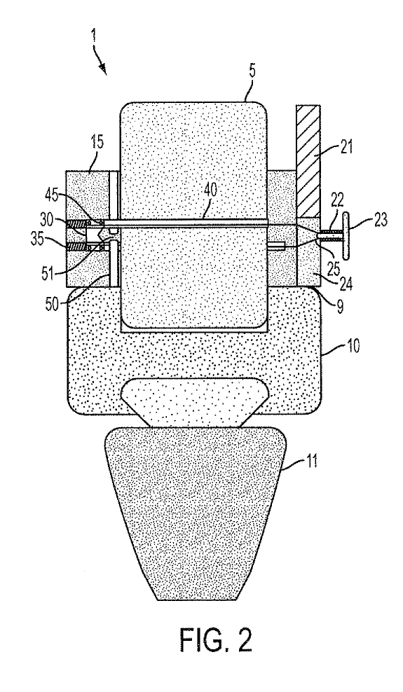

FIG. 1 shows the apparatus of the invention with a point of attachment 9 to the tongue connecter 10 of the seatbelt apparatus 1. The invention has multiple components housed in an Emergency Seatbelt Release (ESR) box 15. The ESR box 15 is securely attached to the tongue 10 and the belt 5 passes through the ESR box. The ESR box 15 contains a sharp razor 30 or other sharp edged cutting instrument, located in the rear of the ESR box 15 and which is mounted securely on two tracks 40 attached to the side walls of the ESR box 15. The razor 30 or other sharp edged cutting instrument is attached to the two tracks 40 by bearings 45 to facilitate the smooth movement of the cutting instrument along the tracks 40 as shown in FIG. 2. The razor 30 or other sharp edged cutting instrument is connected to a trigger handle 23 located in the front of the ESR box 15 by a wire 25 or similar string-like flexible material or other mechanical connection. The dull side of the razor 30 or other sharp edged cutting instrument is pressed against compression springs 35 which are affixed to the rear wall of the ESR box 15. The extension of the compression springs 35 provide additional force to propel the razor 30 or other sharp edged cutting instrument through the belt 5 when the trigger handle 23 is pulled during an emergency.

The dimensions of the ESR box 15 may vary depending on the embodiment of the invention and the configuration of its component. As represented in FIGS. 1 and 2, the dimensions of the invention are approximately 3½ cm×7 cm, with a thickness of about ½ cm. The present invention is designed for use when the tongue 10 and buckle 11 mechanisms of the seatbelt apparatus 1 malfunction during an emergency or the occupant cannot reach or activate the buckle mechanism. The ESR box 15 may be made of metal, plastic, leather, polished wood, sturdy cardboard material or similar materials known to one skilled in the art to which this invention belongs.

In the preferred embodiment of the invention, the sharp edged cutting instrument is a razor 30. The razor 30 is designed for quickly cutting through the seatbelt during an emergency with a minimum of resistance. The sharp edge of the razor 30 may be flat, V-shaped as shown in FIG. 2, or otherwise angled to facilitate the easy cutting of the belt 5. The razor 30 may be made of a variety of suitable metals or other materials with a sharpened edge or refined blade-like edge suitable for slicing and cutting. The razor 30 is mounted on two tracks 40 by four bearings 45 (two on either side of the razor 30), which hold it in place and aid in the smooth movement of the razor 30 from its rest position at the rear of the ESR box 15 to the front of the ESR box.

Two compression springs 35 are firmly attached to the back wall of the ESR box 15 and pressed against the dull edge the razor 30. When the trigger handle 23 is pulled and razor 30 movement is initiated into or through the barrier 50, the compression springs extend and assist in propelling the razor 30 forward. The compression springs 35 may be substituted by other flexible device which provides similar force and is made of metal, plastic, or other suitable material.

Prior to activation, the barrier 50 prevents the razor 30 from moving along the track and avoids the premature or unintended cutting or slicing of the belt 5. The barrier 50 is strategically located between the razor 30 and the belt 5. The barrier 50 may be made of metal, sturdy plastic material, wood or other materials or a combination thereof. In this embodiment, the barrier 50 contains a break-away portion 51 against which the sharp edge of the razor 30 rests. The break-away portion 51 of the barrier 50 may be approximately the width of the razor 30 or slightly larger to allow the razor 30 to move through with ease. This break-away portion 51 is made of an appropriate material known to one skilled in the art, that is sturdy enough to keep the razor 30 in place and resists the force of the compression springs 35 force, but allows the razor 30 to move unrestricted when the additional force from the pulling of the trigger handle 23 is applied. When the trigger handle 23 is pulled, the force exerted on the razor 30 breaks through the break-away portion 51 of the barrier 50 and the compression springs 35 extend and aid in propelling the razor 30 forward, cutting the belt 5 in one smooth motion.

The razor 30 is further connected to the trigger handle 23 at the front of the ESR box 15 by a wire 25 or similar string-like flexible material that runs separately and horizontally adjacent to the two tracks 40 and converge at the tip of the trigger handle 23 in a V-formation. The wire 25 is securely fastened to the trigger handle 23 and may be made of metal, rope/cord, plastic, or other suitable material known to one skilled in the art. The trigger handle 23 may also be connected to the razor 30 by other mechanical connection known to one skilled in the art.

The trigger handle 23 is housed in a pouch 20, 24 located at the front of the ESR box 15 and is hidden from plain view but easily accessible via a sliding door 21. The pouch 20 and 24 is a self contained section of the ESR box 15 with a sliding door 21 which provides easy access to the trigger handle 23 during an emergency. The trigger handle 23 is hidden from plain view inside the pouch 24, as shown in FIG. 1, and is exposed to the user upon the opening of the sliding door 21, as shown in FIG. 2. The trigger handle 23 is stored in the upright or nearly upright position in the pouch 24. Two compression springs 22 are interposed between the trigger handle 23 and the back of the pouch 24, flanking the trigger handle 23, and are held in place by the closed sliding door 21. When the sliding door 21 is opened, the compression springs 22 extend and the trigger handle 23 is automatically ejected from the pouch 24 and the user is able to pull the trigger handle 23 in one forward motion which in turn sets into motion the above described mechanism for the release of the razor 30 and cutting of the belt 5.

In the preferred embodiment of the invention, the point of attachment 9 for the ESR box 15 is to the tongue connecter 10 of the seatbelt apparatus 1. However, in other embodiments of the invention, the ESR box 15 may have an alternate point of attachment to the seatbelt. In other embodiments, the ESR box 15 may be incorporated inside the shell that covers the metal tongue and a portion of the seatbelt or safety harness device. In yet other embodiments, the shell that covers the metal tongue serves as the ESR box 15.

In other embodiments of the invention, the barrier 50 may be made of the same material as the break-away portion 51. This break-away barrier can be made of material that is sturdy enough to keep the razor 30 or other sharp edged cutting instrument from being inadvertently released, but will not restrict the movement of the razor 30 or other sharp edged cutting instrument when the trigger handle 23 is pulled by the user. In an alternate embodiment, the barrier 50 can be made of metal, sturdy plastic material, designed with a tiny slit that allows the razor to pass through when the trigger handle 23 is pulled. This embodiment would include a pin or lever connected to the trigger handle 23 via the wire 25 to release the razor 30 or other sharp edged cutting instrument. It is noted that the tiny slit should be approximately the width the razor 30 or slightly larger for optimum results. In another embodiment, the barrier 50 may not be included, but may be substituted with another apparatus, known to one skilled in the art, that holds the razor 30 or other sharp edged cutting instrument in place and protects the belt material from unintended damage (cutting).

As various changes can be made in the above-described subject matter without departing from the scope and the spirit of the invention, it is intended that all subject matter contained in the above description, shown in the accompanying drawings, or defined in the appended claims will be interpreted as descriptive and illustrative, and not in a limiting sense. Many modifications and variations of the present invention are possible in light of the above teachings. It is therefore to be understood that within the scope of the appended claims, the invention may be practiced otherwise than as specifically described.

### EQUIVALENTS

Those skilled in the art will recognize, or be able to ascertain using no more than routine experimentation, many equivalents to the specific embodiments of the invention described herein. Such equivalents are intended to be encompassed by the claims.

What is claimed is:

1. An apparatus for emergency seatbelt release comprising:
a housing that attaches to the tongue connector portion of a seatbelt and which houses:
a sharp edged cutting instrument in the rear portion of the housing;
two tracks attached to the [top and bottom] sides of the housing walls;
the sharp edged cutting instrument is attached to both tracks by bearings such that the sharp cutting instrument can travel smoothly along the tracks;
two blade compression springs are interposed between the dull side of the sharp cutting instrument and the adjacent rear wall of the housing;
a trigger handle in a compartment in the front of the housing that is connected mechanically to the sharp cutting instrument;
two trigger compression springs are interposed between the trigger handle and back of the compartment;
the two trigger compression springs are in the compressed state when the trigger handle is in the compartment and the blade has not been activated; and
a barrier with a central linear breakaway portion that prevents the sharp edged cutting instrument from releasing and cutting the seatbelt until activated by pulling the trigger handle.

2. An apparatus for emergency seatbelt release comprising:
a housing that is incorporated into the shell that covers the point of connection between the metal tongue and fabric portion of a seatbelt and which houses:
a sharp edged cutting instrument in the rear portion of the housing; two tracks attached to the sides of the housing walls;
the sharp edged cutting instrument is attached to both tracks by bearings such that the sharp cutting instrument can travel smoothly along the tracks;
two blade compression springs are interposed between the dull side of the sharp cutting instrument and the adjacent rear wall of the housing;
a trigger handle in a compartment in the front of the housing that is connected mechanically to the sharp cutting instrument;
two trigger compression springs are interposed between the trigger handle and back of the compartment;
the two trigger compression springs are in the compressed state when the trigger handle is in the compartment and the blade has not been activated; and
a barrier with a central linear breakaway portion that prevents the sharp edged cutting instrument from releasing and cutting the seatbelt until activated by pulling the trigger handle.
